(19) United States
(12) Patent Application Publication
(10) Pub. No.: US 2008/0190263 A1
(43) Pub. Date: Aug. 14, 2008

(54) Sound board support system

(76) Inventor: Darren Drew, Redwood City, CA (US)

Correspondence Address: GREGORY SMITH & ASSOCIATES, 3900 NEWPARK MALL ROAD, 3RD FLOOR, NEWARK, CA, 94560, US

(21) Appl. No.: 11/706,514

(22) Filed: Feb. 13, 2007

(51) Int. Cl. G10D 3/00

(52) U.S. Cl. 84/291

(57) ABSTRACT

A system for supporting a sound board in a string instrument comprises a longitudinal support coupled to opposite ends of a cavity in the body of the instrument and a transverse support coupled to the longitudinal support and to the bridge of the string instrument. A compression force is generated between the bridge and the transverse support to lower a raised sound board, thereby improving the sound of the instrument. Alternatively, the compression force maintains a preferred curvature of a sound board or restores a preferred shape to the instrument body. The transverse support includes adjustable elements to permit attachment of the sound board support system to bridges having a range of variation in a length dimension. In some embodiments, the longitudinal support has an adjustable length and may be made from components sized to fit through a sound hole in the instrument body. The sound board support system may comprise more than one longitudinal support to accommodate installation in instruments having internal obstructions such as braces or sound posts. In some embodiments, the longitudinal support couples to a neck truss in the string instrument or alternatively is an extension of a neck truss. In another embodiment, a string instrument comprising a sound board support system is provided. In another embodiment, a method of lowering a raised sound board in a string instrument is provided.

### FIELD OF THE INVENTION

The present invention relates generally to an improvement in a string instrument and more specifically to an apparatus for maintaining or changing the curvature of a sound board in a string instrument.

### BACKGROUND

Many string instruments of the general type exemplified by guitars, banjos, violins, and cellos have a body that amplifies sounds produced by vibrations of the strings and other parts of the instrument. It has long been recognized that changes in the shape of the body caused by mechanical and environmental stress contribute to a loss in the quality of sound produced by the instrument. Some of the construction practices and material properties that contribute to good sound quality, such as light weight materials, long structures with relatively thin sections, and large through-holes, make the body susceptible to bending and twisting. Some of the problems resulting from bending and twisting of the instrument body include degradation of tonal quality, loss of desirable overtones, reduced acoustic volume, increased difficulty in tuning and playing the instrument, and breaking or separation of instrument structures.

String instruments with hollow bodies are more susceptible to twisting and bending than instruments with solid bodies. A hollow body, also known as a sound box, generally has a relatively thin front element known as a sound board that is made from a material selected for its strength, tonal qualities, and appearance. The sound board, which is flat in some instruments and curved or arched in others, usually has at least one relatively large hole called a sound hole through which amplified sounds are emitted when the instrument is played. A relatively thin sound board is generally believed to contribute to better tonal quality and acoustic volume than a relatively thick sound board, but a thin sound board is more easily bent or twisted. Reinforcing elements called braces are coupled to the surface of the sound board inside the sound box in some instruments to resist bending and twisting and to control acoustic properties. Braces permit a sound board to be thinner and lighter in weight than a sound board without braces. Other parts of the sound box may also be reinforced with braces.

Stresses on other parts of a string instrument also affect the sound box and sound board. A relatively long neck is attached to a side of the sound box. Forces acting on the neck generate torque and compression forces in the sound board and sound box. A neck block is attached to an inside surface of the sound box side adjacent the neck to provide structural reinforcement of the connection between the neck and sound box. A tail block is attached to an inside surface of the sound box side opposite the neck block for additional structural reinforcement. A head stock attached to the outer end of the neck supports string tensioning devices, usually either tuning pegs or tuning machines, to which strings are attached. A tuning key coupled to a tuning peg or tuning machine is turned manually to adjust the tension in a string until the string produces a desired musical note.

The mechanical forces from string tension are substantial. String tension places the upper parts of a sound box in compression, sometimes with enough force to bend the sound box. String tension is also capable of causing a sound board to bend in the area near a vibration coupling element called a bridge. Other aspects of an instrument may also be affected. For example, string tension works to reduce the angle between the front of the neck and the outer surface of the sound board, causing a greater separation between the strings and the neck and making the instrument more difficult to play. Also, as the instrument bends, the strings must be shortened to maintain adequate tension for producing tones, thereby changing the overall pitch of the instrument. In more extreme cases, braces loosen or break, causing changes in overtones or undesirable noises when the instrument is played.

It is especially difficult to build a sound board from wood having a thin profile for good sound quality and sufficient strength to resist bending. Variations in temperature and humidity affect the stiffness and strength of wood and increase the susceptibility to bending. The steady pull exerted by the strings on the sound board near the bridge (where the ends of the strings are anchored in some instruments) gradually raises the sound board, pulling it outward (away from the sound box) from its original position. Bending of the entire sound box also contributes to an outward deflection of the sound board. A raised board generally has lower acoustic volume and less distinct tones than an undistorted sound board. Lowering a raised sound board improves the acoustic volume and tonal quality of an instrument. Even well built string instruments tend to show some degree of change over time in the sound board or sound box, with related losses in acoustic quality.

Previous efforts to restore or maintain a preferred shape of sound box have been directed at adding support members inside the sound box or neck to oppose compression forces from string tension. Some solutions add a support member to the inside of the sound box to apply a restoring force against neck and tail blocks or against other support members installed for the purpose. Other solutions use threaded compression rods or similar adjustment means to move a sliding or rotating structural member coupled to the sound box. The structural modifications and mechanical elements proposed in these earlier solutions are generally installed either at the time an instrument is first constructed or require extensive instrument disassembly and reassembly.

Other efforts have been directed at attaching a backing plate to the inside surface of a sound board and forcing the sound board to conform to the shape of the backing plate. Changing the curvature of the sound board with a backing plate generally requires instrument disassembly. As will be appreciated by one skilled in the art, the thicker and heavier the backing plate needed to change or maintain sound board curvature, the greater the expected alteration in the acoustic character of an instrument modified in this manner. Furthermore, different bracing patterns and varying amounts of sound board bending from instrument to instrument make it difficult to design and manufacture a single configuration for a backing plate to accommodate a variety of sound board conditions.

### SUMMARY

A sound board support system is provided to lower a raised sound board on a string instrument. A longitudinal support is coupled to opposite ends of a cavity in the body of a string instrument. In some embodiments, the longitudinal support is adjustable in length and is comprised of elements sized to fit through a sound hole, thereby permitting the sound board support system to be installed in a string instrument without disassembling the instrument body. In some embodiments, the longitudinal support is coupled to a truss rod in the neck of the string instrument. In other embodiments, the longitudinal support is an extension of the truss rod in the neck. In some embodiments, more than one longitudinal support is coupled to opposite ends of the cavity in the body of the string instrument. A transverse support is coupled to the longitudinal support and to the sound board and bridge of a string instrument. In embodiments having more than one longitudinal support, the transverse support is coupled to each of the longitudinal supports. In some embodiments the transverse support comprises a bracket made from a metal extrusion, bent sheet metal, or a metal bar. In other embodiments the transverse support comprises a metal bridge block adapted for coupling to the longitudinal support and one or more metal bridge bars adapted for adjustable connection to the bridge block and bridge. In some embodiments, the longitudinal support passes through an aperture formed in the transverse support. In other embodiments, the longitudinal support passes through the aperture of an eye bolt and the shaft of the eye bolt passes through an aperture formed about halfway along the long dimension of the transverse support. A nut coupled to the bolt is adjusted to set a preferred separation between the transverse support and the longitudinal support.

A sound board compression fastener is passed through an aperture in the bridge, through a corresponding aperture in the sound board, and through an aperture near an end of the transverse support. Another sound board compression fastener is passed through a corresponding set of apertures at the opposite end of the bridge and transverse support. The sound board compression fasteners are adjusted to lower a raised sound board by a preferred amount. In another embodiment, the sound board compression fasteners are adjusted to prevent tension in the strings from causing a sound board to bend. Alternatively, the sound board compression fasteners are adjusted to improve the sound of a string instrument.

This section summarizes some features of the present embodiment. These and other features, aspects, and advantages of the embodiments of the invention will become better understood with regard to the following description and upon reference to the following drawings, wherein:

### BRIEF DESCRIPTION OF THE DRAWINGS

FIG. 1 is a front view of an acoustic guitar showing an embodiment of a sound board support system.

FIG. 2 is a side view of the guitar and sound board support system of FIG. 1.

FIG. 3 is a front view of a guitar sound box showing relative positions of the components of another embodiment of a sound board support system.

FIG. 4 is a sectional view taken on line 4-4 of FIG. 3.

FIG. 5 is an enlarged fragmentary sectional view taken on line 5-5 of FIG. 3.

FIG. 6 is a front view of a guitar sound box showing relative positions of the components of an embodiment comprising two adjustable longitudinal supports.

FIG. 7 is a front view of a guitar showing relative positions of a truss rod and a main support rod in another embodiment of a sound board support system.

FIG. 8 is a sectional view taken on line 8-8 of FIG. 7.

FIG. 9 is a pictorial view of a bridge bar.

FIG. 10 is a pictorial view of a clamp plate.

FIG. 11 is a pictorial view of a bridge block.

FIG. 12 is a pictorial view of a sound board support system having a transverse support comprising an adjustable bridge bar assembly.

### DESCRIPTION

The examples to follow describe, but are not limited to, embodiments of a sound board support system for a string instrument having a hollow body. The description and figures refer to a guitar as an exemplary string instrument, but other instruments such as banjos, violins, violas, cellos, string basses, and the like, have structures corresponding to those referred to herein and will similarly benefit from the described embodiments.

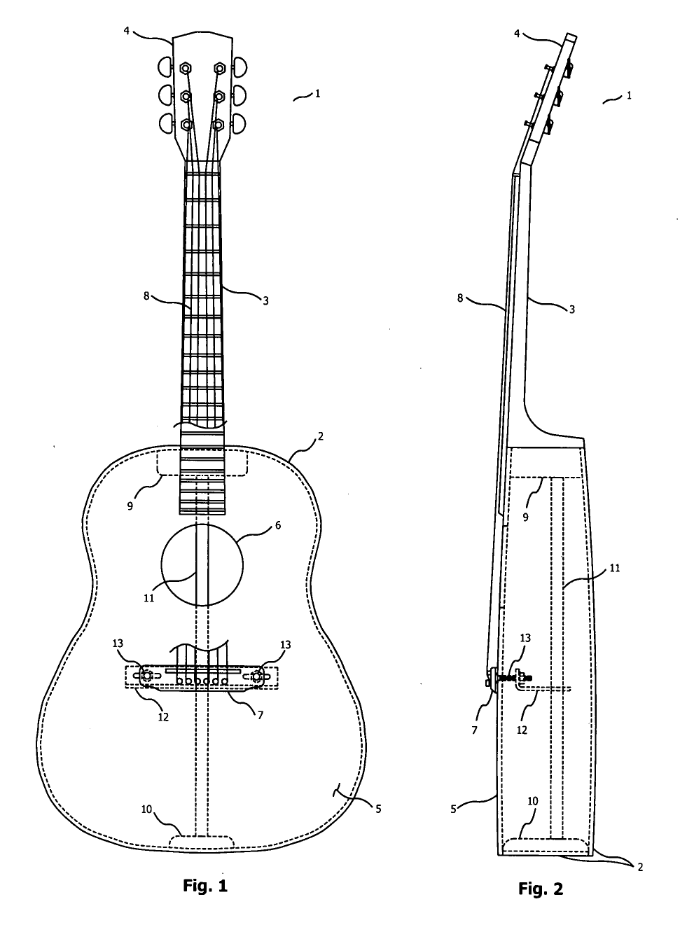

FIG. 1 and FIG. 2 show a string instrument 1 comprising a sound box 2 coupled to a neck 3. A headstock 4 is attached to an end of the neck 3 opposite the sound box 2. A sound board 5 comprises the front surface of the sound box 2. Sound is emitted from the sound box 2 through a sound hole 6 in the sound board 5. A bridge 7 is attached with adhesive, screws, or bolts to the outside surface of the sound board 5 on the front of the sound box 2. A plurality of strings 8 are attached to tension adjustment devices on the headstock 4 and to string-anchoring hardware on the bridge 7. In the front view of FIG. 1, a portion of the strings 8 have been removed to better show some of the details beneath. Inside the sound box 2, a neck block 9 is coupled to a side of the sound box 2 and to the neck 3. A tail block 10 is coupled to a side of the sound box 2 opposite the neck block 9.

FIG. 1 and FIG. 2 show an embodiment of a sound board support system for generating a force to displace a portion of the front surface of the sound board 5 in the area near the bridge 7 toward the sound box 2. A force which acts against the front surface of the sound board 5 to displace a part of the sound board 5 toward the sound box 2, that is, a force which acts to lower a raised sound board, will be referred to herein as a compression force. The illustrated embodiment comprises a longitudinal support 11 coupled to a transverse support 12 inside a sound box 2. In FIG. 1, part of the longitudinal support 11 is visible through the sound hole 6. Some instruments of the general type described do not have a sound hole 6 located near the midline of the sound board 5, so the longitudinal support 11 would not be visible in a front view of such instruments. The longitudinal support 11 is attached at one end to a neck block 9 and at the other end to a tail block 10. In the embodiment illustrated, the transverse support 12 is a dihedral metal bracket. Alternatively, the cross-sectional shape of the transverse support 12 may be U-shaped, T-shaped, or I-shaped, or the transverse support 12 may be formed from a solid or hollow bar. The longitudinal support 11 passes through a hole in the transverse support 12, thereby limiting the displacement of the transverse support 12 toward the sound board 5.

One or more sound board compression fasteners 13 pull the bridge 7 toward the transverse support 12. In the embodiment of FIG. 2, a sound board compression fastener is coupled to the bridge 7, passes through a hole in the sound board 5, and couples to the transverse support 12. The longitudinal support 11 is attached to the neck block 9 and the tail block 10 firmly enough to prevent substantial movement of the transverse support 12 in the direction of the sound board 5 when a sound board compression fastener 13 generates a compression force.

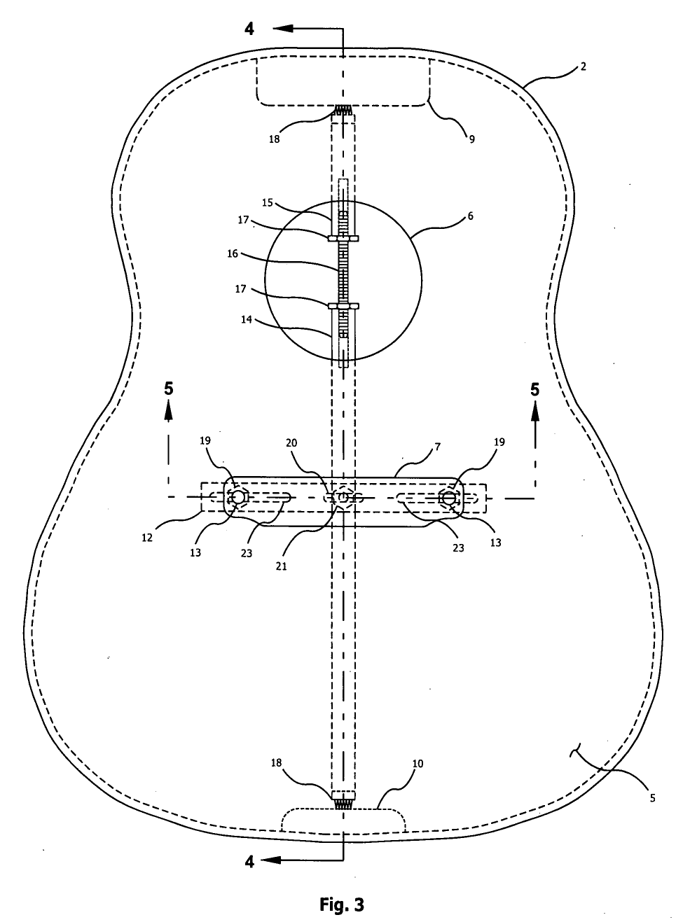

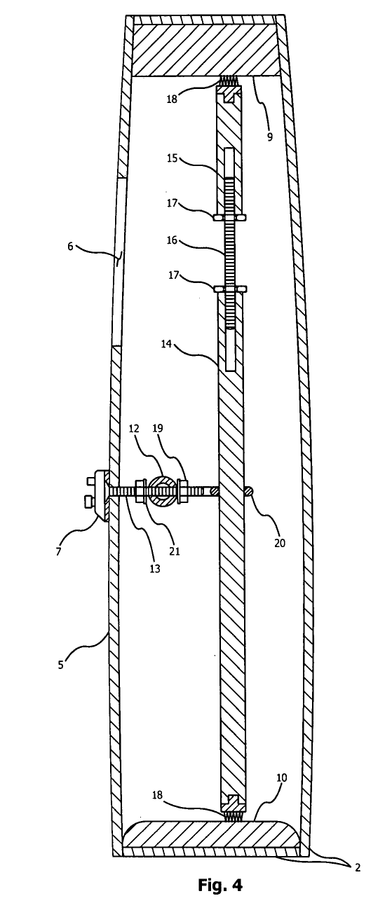

An adjustable longitudinal support may be assembled from a combination of relatively short elements to permit a sound board support system to be installed through a sound hole without disassembling the sound box. FIG. 3 shows a front view of a sound box and a sound board support system having an adjustable longitudinal support. FIG. 4 shows the same embodiment in a sectional view along line 4-4 from FIG. 3. An adjustable longitudinal support comprises a main support rod 14, a secondary support rod 15, a threaded rod 16, one or more tension nuts 17, and one or more block engagements 18.

The lengths of the main support rod 14, secondary support rod 15, and threaded rod 16 are chosen such that each element will pass through the sound hole 6 for assembly inside the sound box 2. The main support rod 14 and secondary support rod 15 may be made from aluminum or steel, but other materials with sufficient compression strength and stiffness are also acceptable. The diameters of the main support rod 14, secondary support rod 15, and threaded rod 16 are selected to limit the deflection of these elements to an acceptable amount when a compression force is applied between the bridge 7, the sound board 5, and elements of the sound board support system.

The main support rod 14 has a first end having an axial hole sized for a sliding fit of the threaded rod 16 and a second end having a block engagement 18. The secondary support rod 15 has a first end having an axial hole sized for a sliding fit of the threaded rod 16 and a second end having a block engagement 18. Two tension nuts 17 are cooperatively coupled to the threaded rod 16 and the ends of the threaded rod 16 are coupled to axial holes in the ends of the main support rod 14 and the secondary support rod 15. One tension nut 17 is adjusted to bear against an end of the main support rod 14 and another tension nut 17 is adjusted to bear against an end of the secondary support rod 15. The positions of the tension nuts 17 along the threaded rod 16 set the overall length of the adjustable longitudinal support.

The main and secondary support rods are prevented from slipping along the faces of the neck and tail blocks by the block engagements 18. In one embodiment, a block engagement 18 comprises a plurality of pointed teeth integrally formed on an end of the main support rod 14. Another block engagement 18 similarly comprises a plurality of pointed teeth integrally formed on an end of the secondary support rod 15. In another embodiment, the block engagement 18 comprises a plurality of pointed teeth integrally formed on a cap with a shoulder and a central plug sized to fit into an axial hole in a support rod, as shown in FIG. 4. In another embodiment, a plurality of separate pins or other sharp, hard elements suitable for penetrating wood are attached to a cap. In another embodiment, a block engagement 18 comprises a cap having a hollow back sized to fit over the outer diameter of the support rods. Pressure exerted by the tension nuts 17 causes the block engagements 18 to couple firmly with the neck block 9 and the tail block 10. Further adjustment of the tension nuts 17 sets a preferred angle between the outside surface of the sound board 5 and the front surface of the neck 3.

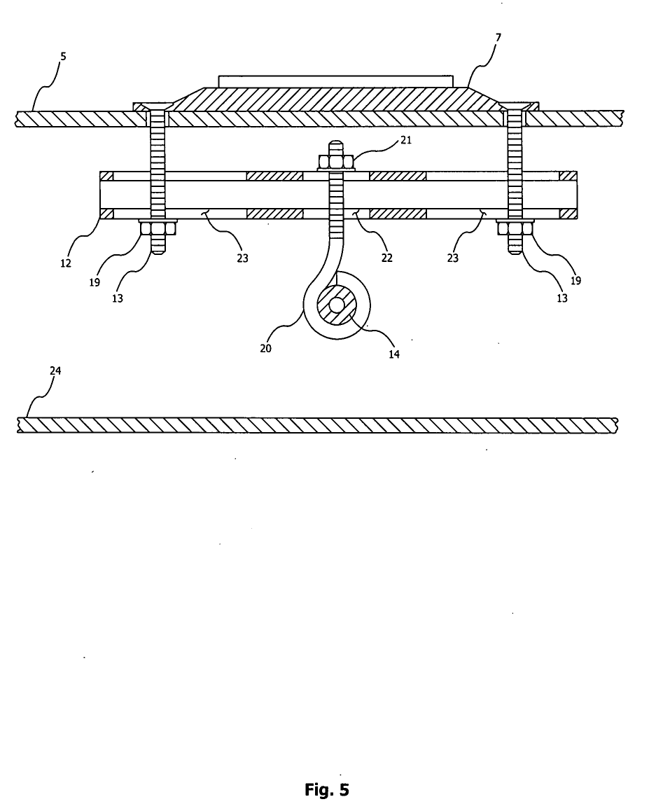

Compression force is coupled between the bridge 7, the sound board 5, and the adjustable longitudinal support through a transverse support 12. In a previously described embodiment, the transverse support 12 comprises a bracket. In another embodiment, the adjustable longitudinal support is coupled to a transverse support 12 comprising a hollow metal bar, as shown in the enlarged sectional view of FIG. 5. In other embodiments the transverse support 12 comprises a solid bar or an adjustable bridge bar assembly. The viewing direction for FIG. 5 is indicated by the line 5-5 in FIG. 3. In the embodiment illustrated in FIG. 3, FIG. 4, and FIG. 5, the transverse support 12 has a round cross section. In other embodiments, the transverse support has a square or rectangular cross section, or any other cross section able to withstand sound board compression forces without an undesirable amount of bending.

In another embodiment, a transverse support is provided with adjustable connection to a longitudinal support. As illustrated in FIG. 4 and FIG. 5, the transverse support 12 is positioned on the inside of the sound box 5 under the bridge 7. Two end apertures 23 penetrate the width of the transverse support 12, one aperture near each end of the long axis of the transverse support 12 and the two apertures parallel to each other. The end apertures 23 are sized for a sliding fit of a sound board compression fastener 13. A central aperture 22 penetrates the transverse support 12 about midway along the long axis of the support and parallel to the end apertures 23. The central aperture 22 is sized for a sliding fit of the shaft of a longitudinal support fastener 20.

The transverse support rod 12 is adjustably positioned relative to the main support rod 14 and the bridge 7 as shown in FIG. 5. The main support rod 14 passes through an aperture in an end of a longitudinal support fastener 20. The shaft of the longitudinal support fastener 20 passes through a central aperture 22 in the transverse support 12 and is retained with a nut 21 cooperatively coupled to the shaft. The nut 21 is adjusted to set a preferred distance between the transverse support 12 and the main support rod 14. Exemplary positions of the main support rod 14 and transverse support 12 relative to the sound board 5 and sound box back 24 are shown in FIG. 5. Examples of longitudinal support fastener 20 include, but are not limited to, an eye bolt and a J bolt.

In some instruments, the bridge 7 is attached to the sound board 5 with bolts or screws. The bolts or screws are removed before installing a sound board support system. If necessary, the diameter of holes in the bridge and sound board are increased to allow shaft clearance for the sound board compression fasteners 13. In other instruments, the bridge 7 is attached to the sound board 5 with adhesive, in which case holes are drilled through the bridge and sound board to allow shaft clearance for the sound board compression fasteners 13.

A sound board compression fastener 13 is passed through a hole in the bridge 7, through a corresponding hole in the sound board 5, and through an end aperture in the transverse support 12. A nut 19 is cooperatively coupled to the sound board compression fastener and adjusted to provide a preferred amount of compression force between the bridge 7, the sound board 5, and the transverse support 12. A second sound board compression fastener 13 and nut 19 are similarly coupled to another hole in the bridge 7, a corresponding hole in the sound board 5, and an end aperture in the transverse support 12. The nuts 19 on the sound board compression fasteners 13 are adjusted to set preferred separations between the surface of the sound board 5 and the transverse support 12 and between the transverse support 12 and the sound box back 24. The transverse support 12 and the main support rod 14 are positioned so as to avoid contact with braces. The nuts 19 on the sound board compression fasteners 13 and the nut 21 on the longitudinal support fastener 20 are adjusted further to lower a raised sound board 5 by a preferred amount. Alternatively, the nuts are adjusted to maintain a preferred curvature of the sound board 5 or to improve the quality of sound emitted by the string instrument.

A hex nut is an example of a nut 19 coupled to a sound board compression fastener 13 and a nut 21 coupled to the longitudinal support fastener 20. In other embodiments, nuts are hex flange lock nuts, nylon-insert lock nuts, hex nuts with an attached lock washer, or hex nuts in combination with a washer and a lock washer. Any of these alternatives provide a combination that will resist loosening from vibration and temperature cycling.

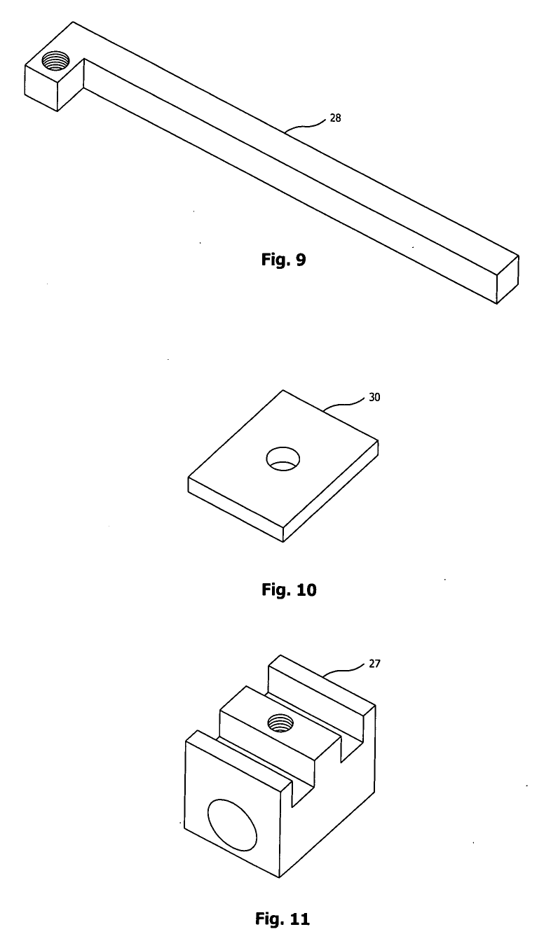

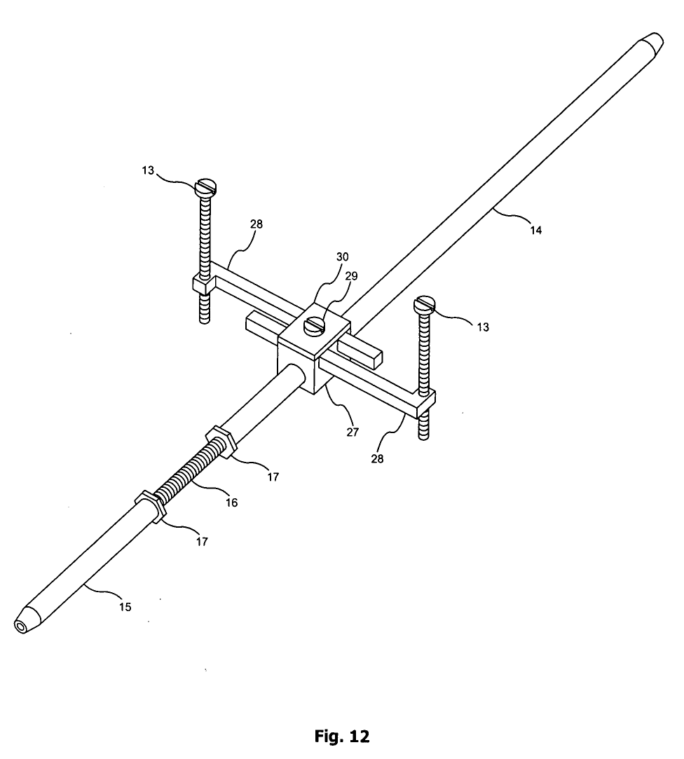

In another embodiment, the transverse support comprises an adjustable bridge bar assembly. The adjustable bridge bar assembly provides a greater range of adjustment and comprises fewer components than embodiments of the transverse support described above. The adjustable bridge bar assembly comprises a bridge bar 28, illustrated in FIG. 9, a clamp plate, illustrated in FIG. 10, a bridge block, illustrated in FIG. 11, and a threaded clamp fastener 29. A sound board support system comprising an adjustable longitudinal support and an adjustable bridge bar assembly is shown in FIG. 12.

As shown in FIG. 11 and FIG. 12, a bridge block 27 has a through-hole adapted for a sliding fit over the main support rod 14. Alternatively, the secondary support rod 15 is positioned through the through-hole in the bridge block 27. A first bridge bar 28 is positioned within a channel formed in a side of the bridge block 27 and a second bridge bar 28 is positioned within an adjacent channel in the bridge block 27. The first and second bridge bars 28 are positioned within the channels so that a threaded hole in the end of each bridge bar aligns with the corresponding holes in the sound board and bridge of the stringed instrument. A clamp plate 30 is positioned so as to contact a surface on both bridge bars, the bridge bars having a thickness dimension that is somewhat greater than a depth dimension of the channels in the bridge block 27. A threaded clamp fastener 29 passes through a hole formed in the clamp plate 30 and engages a threaded hole formed in the bridge block 27 between the channels. The clamp plate 30 may alternately be replaced with a round washer having an outer diameter large enough to contact both bridge bars. Tightening the clamp fastener 29 against the clamp plate 30 causes the bridge bars 28 to be held firmly in place. A first sound board compression fastener 13 is passed through a hole in the bridge, through a hole in the soundboard, and attaches to the threaded hole at the end of the first bridge bar 28. A second sound board compression fastener 13 is similarly attached to the second bridge bar 28. The sound board compression fasteners are tightened to provide a compression force between the bridge and the bridge bars, thereby exerting force on the sound board to alter its curvature.

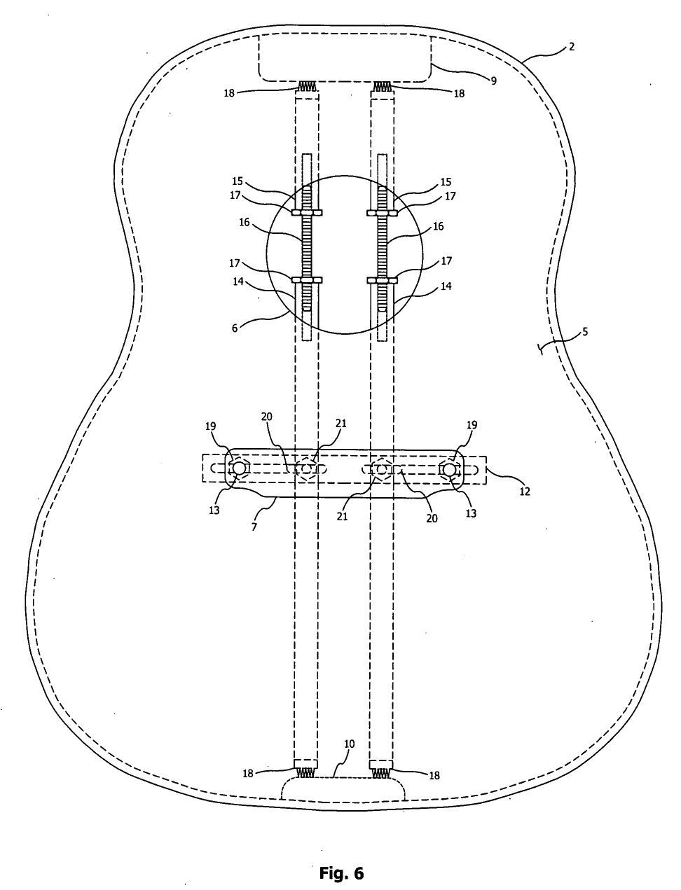

In another embodiment, two adjustable longitudinal supports are coupled to a modified transverse support 12, as shown in FIG. 6. The arrangement of FIG. 6 is useful when an obstruction inside the sound box of an instrument, such as a bass bar or sound post, interferes with the placement of a single support bar assembly. Another aspect of an embodiment with two adjustable longitudinal supports is that the longitudinal supports may be independently positioned and set with differing amounts of holding pressure with the tension nuts 17 and longitudinal support fasteners 20 to restore a sound box 2 or a sound board 5 to a desired shape. Alternatively, the transverse support 12 shown in FIG. 6 may be replaced by two adjustable bridge bar assemblies, one adjustable bridge bar assembly coupled to each longitudinal support, and each adjustable bridge bar assembly comprising a bridge block 27, a bridge bar 28, a clamp plate 30, and a clamp fastener 29.

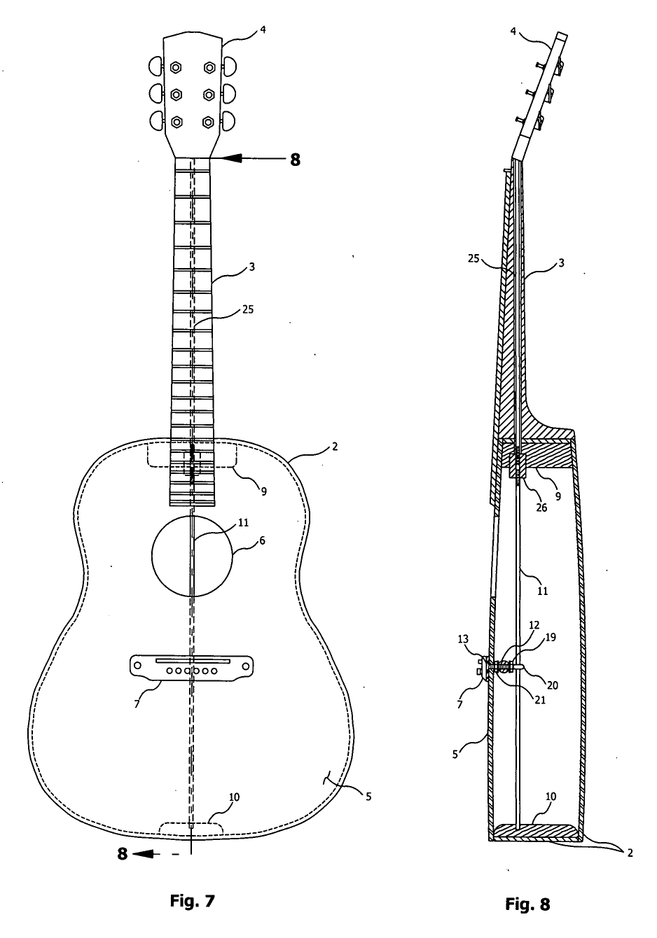

An embodiment of a sound board support system that takes advantage of the presence of a truss rod in the neck of a string instrument is shown in FIG. 7 and FIG. 8. In some instruments, a truss rod 25 is installed in a channel or hole along the length of the neck 3 and is firmly anchored at one end in the neck 3 near the head stock 4. A longitudinal support 11 is firmly attached at one end to the truss rod 23 and to the tail block 10 at the other end. The transverse support 12, sound board compression fasteners 13 and nuts 19, and longitudinal support fastener 20 and nut 21 are assembled to each other and coupled to the bridge 7 and the longitudinal support 11 as previously described for other embodiments. In one embodiment, a first end of the longitudinal support 11 is retained in a hole in the tail block 10. In other embodiments an end of the longitudinal support 11 is secured by a clip, collared sleeve, or similar hardware attached to the tail block 10. In some embodiments an end of the longitudinal support 11 is threaded, an end of the truss rod 25 is threaded, and the threaded ends are joined with an internally threaded sleeve 26. In other embodiments, the longitudinal support 11 extends into the neck 3 and is connected to the truss rod 25 by welding, by a clip, by one or more U-bolts, or by similar strong attachment means. In another embodiment, a single support member is installed in the neck 3 and the sound box 2 to combine the functions of a longitudinal support and neck truss. Nuts 19 on the sound board compression fasteners 13 and the nut 21 on the longitudinal support fastener 20 are adjusted to give firm support to the sound board 5, and are readjusted periodically to compensate for changes in the shape of the sound board caused by use and variations in temperature and humidity.

The present disclosure is to be taken as illustrative rather than as limiting the scope, nature, or spirit of the subject matter claimed below. Numerous modifications and variations will become apparent to those skilled in the art after studying the disclosure, including use of equivalent functional and/or structural substitutes for elements described herein, use of equivalent functional couplings for couplings described herein, or use of equivalent functional steps for steps described herein. Such insubstantial variations are to be considered within the scope of what is contemplated here. Moreover, if plural examples are given for specific means, or steps, and extrapolation between or beyond such given examples is obvious in view of the present disclosure, then the disclosure is to be deemed as effectively disclosing and thus covering at least such extrapolations.

Unless expressly stated otherwise herein, ordinary terms have their corresponding ordinary meanings within the respective contexts of their presentations, and ordinary terms of art have their corresponding regular meanings.

What is claimed is:

1. A system for supporting a sound board in a string instrument, comprising:
a longitudinal support having a first end coupled to a side of the string instrument and a second end coupled to an opposite side of the string instrument;
a transverse support coupled to said longitudinal support; and
a sound board compression fastener having a first end in contact with a bridge of the string instrument and a second end adjustably connected to said transverse support.

2. The system for supporting a sound board in a string instrument as claimed in claim 1, wherein said sound board compression fastener is adjusted to improve a quality of sound produced by the string instrument.

3. The system for supporting a sound board in a string instrument as claimed in claim 2, wherein said sound board compression fastener is adjusted to support a preferred curvature of the sound board.

4. The system for supporting a sound board in a string instrument as claimed in claim 3, wherein said sound board compression fastener is adjusted to lower a raised sound board.

5. The system for supporting a sound board in a string instrument as claimed in claim 4, wherein said longitudinal support has an adjustable length.

6. The system for supporting a sound board in a string instrument as claimed in claim 5, wherein said longitudinal support comprises:
a threaded rod;
a main support rod having a first end with an axial aperture sized for a sliding fit of said threaded rod and a second end adapted to attach to an inside surface of a sound box of the string instrument;
a secondary support rod having a first end with an axial aperture sized for a sliding fit of said threaded rod and a second end adapted to attach to an inside surface of the sound box of the string instrument; and
at least two tension nuts cooperatively assembled to said threaded rod, wherein a first end of said threaded rod is positioned within said axial aperture on said first end of said main support rod, a second end of said threaded rod is positioned within said axial aperture in said first end of said secondary support rod, one of said tension nuts bears against said first end of said main support rod and one of said tension nuts bears against said first end of said secondary support rod, and an adjustment of said tension nuts correspondingly adjusts a length of said longitudinal support.

7. The system for supporting a sound board in a string instrument as claimed in claim 6, further comprising a second longitudinal support.

8. The system for supporting a sound board in a string instrument as claimed in claim 6, wherein said transverse support comprises:
a bridge block formed with at least two parallel channels in a first face, a threaded aperture in said first face, and a through-hole sized for a sliding fit of said longitudinal support formed in a second face perpendicular to said first face;
a bridge bar sized for a sliding fit in said parallel channels in said bridge block, said bridge bar having an aperture formed near one end, said aperture adapted to adjustably engage with said sound board compression fastener;
a clamp fastener sized to engage with said threaded aperture in said bridge block; and
a clamp plate formed with an aperture sized for a clearance fit of said clamp fastener, wherein said longitudinal support is positioned through the through-hole in said second face of said bridge block, said bridge bar is positioned in a first parallel channel in said first face of said bridge block, a surface of said clamp plate is placed in contact with a surface of said bridge bar, said clamp fastener cooperative joins said clamp plate to said bridge block, and said clamp fastener is adjusted to firmly hold said bridge bar between said clamp plate and said bridge block.

9. The system for supporting a sound board in a string instrument as claimed in claim 8, further comprising:
a second bridge bar, wherein said second bridge bar is positioned in a second parallel channel in said first face of said bridge block; and
a sound board compression fastener having a first end in contact with the bridge of the string instrument and a second end adjustably connected to said second bridge bar.

10. The system for supporting a sound board in a string instrument as claimed in claim 6, wherein said transverse support comprises a bar having a slotted aperture formed near a first end, a central aperture formed about halfway along a length of said bar, and a slotted aperture formed near a second end.

11. The system for supporting a sound board in a string instrument as claimed in claim 10, further comprising:
a second sound board compression fastener;
a longitudinal support fastener having a first end with a threaded shaft and a second end with an aperture sized for a sliding fit of said longitudinal support;
a first nut sized to engage with said threaded shaft on said longitudinal support fastener;
a second nut sized to engage with said sound board compression fastener; and
a third nut sized to engage with said second sound board compression fastener, wherein said longitudinal support passes through said aperture in said second end of said longitudinal support fastener, said first end of said longitudinal support fastener passes through said central aperture in said bar, said first nut is cooperatively assembled to said longitudinal support fastener, said first nut is adjusted to provide a preferred separation distance between said longitudinal support and said transverse support, an end of said sound board compression fastener passes through said slotted aperture near said first end of said bar, said second nut is cooperatively assembled to said sound board compression fastener, an end of said second sound board compression fastener passes through said slotted aperture near said second end of said bar, said third nut is cooperatively assembled to said second sound board compression fastener, and said sound board compression fastener, said second sound board compression fastener, said second nut, and said third nut are adjusted to provide a preferred amount of compression force between said transverse support and the bridge of the string instrument.

12. A method of changing the curvature of a sound board in a string instrument, comprising the steps:
inserting a longitudinal support through a sound hole in the string instrument;
attaching a first end of the longitudinal support to a first surface of the string instrument;
attaching a second end of the longitudinal support to a second surface of the string instrument;
adjusting a length of the longitudinal support to prevent the longitudinal support from slipping on the first or second surfaces;
attaching a transverse support to the longitudinal support and to a bridge of the string instrument so that a gap remains between the transverse support and a back surface of the sound board; and
applying a compression force between the longitudinal support, the transverse support, and the bridge to change the curvature of the sound board by a desired amount.

13. A string instrument comprising:
a body having a sound board, a back surface, a first side, and a second side opposite to said first side;
a bridge coupled to said sound board;
a longitudinal support having a first end coupled to said first side and a second end coupled to said second side;
a transverse support coupled to said longitudinal support; and
a sound board compression fastener having a first end in contact with said bridge and a second end adjustably connected to said transverse support, wherein said sound board compression fastener is adjusted to maintain a preferred shape of the sound board.

14. A string instrument made by the process of:
forming a body comprising sides and a back, said body being formed with a cavity therein;
forming a front cover, wherein said front cover is large enough to cover said cavity;
coupling a bridge to an outside surface of said front cover;
coupling a longitudinal support to opposite ends of said cavity;
coupling a transverse support to said longitudinal support;
coupling said front cover to said body;
coupling said bridge to said transverse support; and
applying a compression force between said bridge and said transverse support to maintain a preferred shape of said front cover.
